(19) United States
(12) Patent Application Publication
(10) Pub. No.: US 2025/0389549 A1
(43) Pub. Date: Dec. 25, 2025

(54) METHOD AND APPARATUS FOR OPERATING AN ENVIRONMENTAL SENSOR SYSTEM

(71) Applicant: Robert Bosch GmbH, Stuttgart (DE)

(72) Inventor: Jan Rohde, Dettingen Unter Teck (DE)

(21) Appl. No.: 19/234,363

(22) Filed: Jun. 11, 2025

(30) Foreign Application Priority Data
Jun. 20, 2024 (DE) 10 2024 205 705.3

(51) Int. Cl. G01C 21/00

(52) U.S. Cl. CPC G01C 21/3841; G01C 21/3878

(57) ABSTRACT

A method and apparatus for providing an optimization function for operating an environmental sensor system. The method includes: receiving a plurality of environmental data value sets, wherein each environmental data value set was sensed using sensors of a vehicle, wherein each environmental data value set represents an environment of the vehicle, and each environmental data value set includes at least one time point and/or one item of position information of the sensing of the corresponding environment; creating a digital map according to the environmental data value sets, wherein the creating includes multiple sub-steps, and at least some sub-steps include monitoring algorithms which each generate a quality indicator of the sub-step carried out accordingly; aggregating the quality indicators and determining the optimization function according to the aggregated quality indicators; and providing the optimization function for operating an environmental sensor system.

### CROSS REFERENCE

The present application claims the benefit under 35 U.S. C. § 119 of German Patent Application No. DE 10 2024 205 705.3 filed on Jun. 20, 2024, which is expressly incorporated herein by reference in its entirety.

### SUMMARY

The present invention relates, among other things, to a method for providing an optimization function for operating an environmental sensor system. According to an example embodiment of the present invention, in the method, a plurality of environmental data value sets are received and a digital map is created according to the environmental data value sets; the creating of the digital map comprises multiple sub-steps, and at least some sub-steps comprise monitoring algorithms which each generate a quality indicator of the sub-step carried out accordingly. Then, the quality indicators are aggregated and the optimization function is determined according to the aggregated quality indicators and is provided for operating the environmental sensor system.

According to an example embodiment of the present invention, a method for providing an optimization function for operating an environmental sensor system comprises a step of receiving a plurality of environmental data value sets, wherein each environmental data value set was sensed by means of sensors of a vehicle, wherein each environmental data value set represents an environment of the particular vehicle, and wherein each environmental data value set comprises at least one time point and/or one item of position information of the sensing of the corresponding environment. The method also comprises a step of creating a digital map according to the environmental data value sets, wherein the creating of the digital map comprises multiple sub-steps, and wherein at least some sub-steps comprise monitoring algorithms which each generate a quality indicator of the sub-step carried out accordingly, a step of aggregating the quality indicators and determining the optimization function according to the aggregated quality indicators, and a step of providing the optimization function for operating an environmental sensor system.

An environmental sensor system is understood to mean at least one video sensor and/or at least one radar sensor and/or at least one lidar sensor and/or at least one ultrasonic sensor and/or at least one further sensor which is designed to sense an environment of a vehicle, in particular the environmental features of this environment. In one possible example embodiment of the present invention, the environmental sensor system comprises, for example, a computing unit (processor, memory, hard drive) with suitable software and/or is connected to such a computing unit.

Vehicle sensors are understood to mean video sensors and/or radar sensors and/or lidar sensors and/or ultrasonic sensors and/or further sensors which are designed to sense an environment of a vehicle in the form of sensor data values.

An environmental feature is understood here to mean, for example, an infrastructure feature (road boundary lines, guard rails, etc.) and/or a traffic sign (road signs, traffic lights, etc.) and/or a structural feature (buildings, bridges, tunnels, etc.) and/or a further feature which can be sensed by means of an environmental sensor system.

Each environmental data value set comprises at least one time point and/or one item of position information of the sensing of the corresponding environment. The environmental data value sets may contain, for example, further information, such as traffic information and/or weather information and/or context information (for example, detailed information about the driving scenario, optionally with the aid of detailed map information), etc.

A digital map is understood to mean a map in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein environmental features comprised by the radar map are stored along with a radar signature. A further map layer comprises, for example, a lidar map, wherein environmental features comprised by the lidar map are stored along with a lidar signature.

In one example embodiment of the present invention, the map is in the form of a highly accurate map. The highly accurate map is in particular configured to be suitable for the navigation of an automated vehicle. For example, this is understood to mean that the highly accurate map is configured to determine a highly accurate position of this automated vehicle by comparing stored environmental features with sensed sensor data values of the automated vehicle. To this end, the highly accurate map comprises, for example, these environmental features with highly accurate position information (coordinates). A map is understood to mean, in particular, a globally accurate map.

A highly accurate position is understood to mean a position that is accurate within a predetermined coordinate system, for example WGS84 coordinates, to such a degree that this position does not exceed a maximum allowable uncertainty. The maximum uncertainty may depend on the environment, for example. Furthermore, the maximum uncertainty can depend, for example, on whether a vehicle is operated manually or in a partially, highly or fully automated manner (corresponding to one of SAE levels 1 to 5). In principle, the maximum uncertainty is so low that a safe operation of the automated vehicle is in particular ensured. For a fully automated operation of the automated vehicle, the maximum uncertainty is, for example, on the order of magnitude of about 10 centimeters.

An automated vehicle is understood to mean a partially automated, highly automated, or fully automated vehicle in accordance with one of SAE levels 1 to 5 (see the SAE J3016 standard).

Creating the digital map is understood to mean, for example, that environmental features encompassed by the environmental data values are newly integrated into a base map according to their position and/or corresponding environmental features already encompassed by the base map are removed or adapted. A base map is understood here to mean, in particular, a digital map (as described above).

According to an example embodiment of the present invention, providing the optimization function for operating an environmental sensor system is understood to mean, for example, that this optimization function is provided in the form of digital data such that it can be requested and received by a vehicle having a corresponding environmental sensor system, for example via radio link.

An optimization function is understood to mean, for example, signals that lead to adjustment of one or more sensors of the environmental sensor system. The optimization function may include, for example, adjustment of the transmission frequency and/or evaluation frequency of a lidar sensor/radar sensor and/or the light sensitivity of a video sensor. Furthermore, the optimization function may also include commands for visually and/or audibly outputting, in the corresponding vehicle, signals which represent a state of the environmental sensor system.

The method according to the present invention advantageously achieves the object of providing a method for providing an optimization function for operating an environmental sensor system. In order to ensure high quality of the (digital) map, various monitoring algorithms are used along the processing chain for map creation (in this case the respective sub-steps), the monitoring algorithms each generating a quality indicator of the sub-step carried out accordingly. The aforementioned object is achieved using the method according to the present invention in particular by virtue of the fact that these quality indicators or items of information are provided from the executed monitoring algorithms—as a service—in order, for example, to optimize a corresponding environmental sensor system. This advantageously has the result that, for example, an assessment of environmental sensor system performance can be carried out for individual vehicles, without further measures on the part of the vehicles.

Preferably, the quality indicators include information about filtered-out and/or inconsistent data.

According to an example embodiment of the present invention, the monitoring algorithms include, for example, consistency checks (filtering of (sensor) data which are inconsistent in relation to a majority of the available data as a whole) and quality assessments (assessment of the quality of the associated output of a sub-step in the processing chain or mapping pipeline for creating the (digital) map). The quality indicators thus represent the results of the respective monitoring algorithms in the form of digital information.

These results of the monitoring algorithms may thus provide, for example, indications of (fundamental) problems with an environmental sensor system or with individual sensors, such as inconsistencies of individual environmental data value sets with other environmental data value sets, false positives (a majority of other environmental data value sets do not contain a particular object), and inconsistent semantics of (individual) objects.

According to an example embodiment of the present invention, preferably, in one of the sub-steps, environmental features are extracted from the environmental data values. Here, the corresponding quality indicator represents a statistical frequency of the environmental features.

For example, the available environmental data value sets are associated and are transformed into a common coordinate system. Then, the transformed environmental data value sets are combined (e.g., 100 measurements of a traffic sign combined to form a map attribute). On the basis of this, statistical frequencies or statistics relating to the sensors used can be created in the fleet data statistics calculation. The following advantageous statistics are proposed: information about false negatives (i.e., the environmental sensor system or the sensor did not detect an object), information about false positives (i.e., the environmental sensor system or the sensor detected an object that does not actually exist), and further statistics such as a misclassification rate.

According to an example embodiment of the present invention, the apparatus, in particular a computing unit, is configured to carry out all steps of the method for providing an optimization function for operating an environmental sensor system. A computing unit is understood to mean, for example, a server or server network, or a cloud.

According to an example embodiment of the present invention, the apparatus or the computing unit comprises a processor, memory, a storage medium, as well as suitable software for carrying out the method according to one of the example embodiments of the present invention. Furthermore, the apparatus comprises an interface for transmitting and receiving data values by means of a wired and/or wireless connection, for example with corresponding devices of vehicles (control units, communication devices, environmental sensor system, navigation system, etc.) and/or further off-board devices (server, cloud, etc.).

Also provided according to an example embodiment of the present invention is a computer program comprising instructions which, when the computer program is executed by a computer, prompt the computer to carry out a method according to one of the method of one of the example embodiments of the present invention for providing an optimization function for operating an environmental sensor system. In one embodiment, the computer program corresponds to the software comprised by the second apparatus.

Furthermore, a machine-readable storage medium on which the computer program is stored is provided according to an example embodiment of the present invention.

Advantageous developments of the present invention are disclosed herein.

### BRIEF DESCRIPTION OF THE DRAWINGS

Embodiment examples of the present invention are illustrated in the figures and explained in greater detail in the following description.

FIG. 1 shows an embodiment example of the method according to the present invention for providing an optimization function for operating an environmental sensor system in the form of a flowchart.

### DETAILED DESCRIPTION OF EXAMPLE EMBODIMENTS

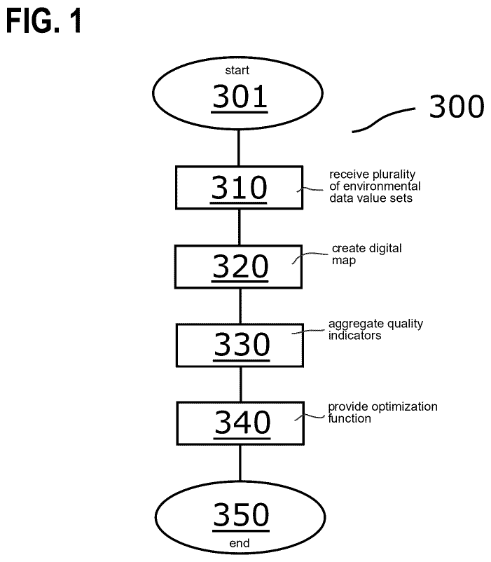

FIG. 1 shows an embodiment example of a method 300 for operating 340 an environmental sensor system according to the present invention.

In step 301, the method 300 starts.

In step 310, a plurality of environmental data value sets are received, wherein each environmental data value set was sensed by means of sensors of a vehicle, wherein each environmental data value set represents an environment of the particular vehicle, and wherein each environmental data value set comprises at least one time point and/or one item of position information of the sensing of the corresponding environment.

In step 320, a digital map is created according to the environmental data value sets. This step comprises multiple sub-steps, at least some sub-steps comprising monitoring algorithms which each generate a quality indicator of the sub-step carried out accordingly.

In step 330, the quality indicators are aggregated and the optimization function is determined according to the aggregated quality indicators.

In step 340, the optimization function is provided for operating an environmental sensor system.

In step 350, the method 300 ends.

What is claimed is:

1. A method for providing an optimization function for operating an environmental sensor system, comprising the following steps:
receiving a plurality of environmental data value sets, wherein each environmental data value set was sensed using sensors of a vehicle, wherein each environmental data value set represents an environment of the vehicle, and wherein each environmental data value set includes at least one time point and/or one item of position information of the sensing of the environment;
creating a digital map according to the environmental data value sets, wherein the creating of the digital map includes multiple sub-steps, and wherein at least some sub-steps include monitoring algorithms which each generate a corresponding quality indicator of the sub-step carried out;
aggregating the quality indicators and determining the optimization function according to the aggregated quality indicators; and
providing the optimization function for operating an environmental sensor system.

2. The method according to claim 1, wherein the quality indicators include information about filtered-out and/or inconsistent data.

3. The method according to claim 1, wherein, in one of the sub-steps, environmental features are extracted from the environmental data values and the corresponding quality indicator represents a statistical frequency of the environmental features.

4. An apparatus, comprising:
a computing unit configured to provide an optimization function for operating an environmental sensor system, the computing unit configured to:
receive a plurality of environmental data value sets, wherein each environmental data value set was sensed using sensors of a vehicle, wherein each environmental data value set represents an environment of the vehicle, and wherein each environmental data value set includes at least one time point and/or one item of position information of the sensing of the environment;
create a digital map according to the environmental data value sets, wherein the creating of the digital map includes multiple sub-steps, and wherein at least some sub-steps include monitoring algorithms which each generate a corresponding quality indicator of the sub-step carried out;
aggregate the quality indicators and determining the optimization function according to the aggregated quality indicators; and
provide the optimization function for operating an environmental sensor system.

5. A non-transitory machine-readable storage medium on which is stored a computer program for providing an optimization function for operating an environmental sensor system, the computer program, when executed by a computer, causing the computer to perform the following steps:
receiving a plurality of environmental data value sets, wherein each environmental data value set was sensed using sensors of a vehicle, wherein each environmental data value set represents an environment of the vehicle, and wherein each environmental data value set includes at least one time point and/or one item of position information of the sensing of the environment;
creating a digital map according to the environmental data value sets, wherein the creating of the digital map includes multiple sub-steps, and wherein at least some sub-steps include monitoring algorithms which each generate a corresponding quality indicator of the sub-step carried out;
aggregating the quality indicators and determining the optimization function according to the aggregated quality indicators; and
providing the optimization function for operating an environmental sensor system.
